(19) United States
(12) Patent Application Publication
(10) Pub. No.: US 2023/0198306 A1
(43) Pub. Date: Jun. 22, 2023

(54) WIRELESS DEVICE CHARGER

(71) Applicant: Bennet Langlotz, Dallas, TX (US)

(72) Inventor: Bennet Langlotz, Dallas, TX (US)

(21) Appl. No.: 17/552,769

(22) Filed: Dec. 16, 2021

(51) Int. Cl. H02J 50/10; H02J 7/00

(52) U.S. Cl. CPC H02J 50/10; H02J 7/0044; H02J 7/0036

(57) ABSTRACT

A charger for an electronic device has a wireless transducer, the charger comprises a frame having a device support surface configured to support the device, and a charging element connected to the frame and configured to transmit charging energy to the transducer of a device on the support surface, and a sensor connected to the frame and operable to determine whether a device is present on the support surface, and an annunciator. It has a controller connected to the frame, to the transducer, to the charging element, and to the annunciator; and the controller is responsive to determine a fault condition in which the sensor determines that a device is present on the support surface but the charging element is not transmitting charging energy, and to activate the annunciator in response to the fault condition.

### FIELD OF THE INVENTION

The present invention relates to wireless charging of smart devices.

### BACKGROUND AND SUMMARY

Wireless chargers employ electrical coils that generate a magnetic field to transfer energy and charge a battery in a device such as a smart phone. These avoid the need for cords and plugging and unplugging devices. They require alignment of the device coil to the charger coil. Some chargers address this by using magnets in the device and coil to force the device into alignment, and provide tactile verification of the correct position. Other devices use multiple coils in the charger to allow for a range of different operable positions.

But these require added resources, such as requiring specially designed devices with additional components, and may be incompatible with existing devices.

The above disadvantage is addressed by a charger for an electronic device has a wireless transducer, the charger comprises a frame having a device support surface configured to support the device, and a charging element connected to the frame and configured to transmit charging energy to the transducer of a device on the support surface, and a sensor connected to the frame and operable to determine whether a device is present on the support surface, and an annunciator. It has a controller connected to the frame, to the transducer, to the charging element, and to the annunciator; and the controller is responsive to determine a fault condition in which the sensor determines that a device is present on the support surface but the charging element is not transmitting charging energy, and to activate the annunciator in response to the fault condition.

### BRIEF DESCRIPTION OF THE DRAWINGS

FIG. 1 is a sectional schematic side view of the device according to a preferred embodiment of the invention.

FIG. 2 shows an alternate embodiment in which a switch 40 is connected to the frame and to the controller and has an arm 42 that is depressed by a resting present device to actuate the switch, and is in the dashed position when no device it present.

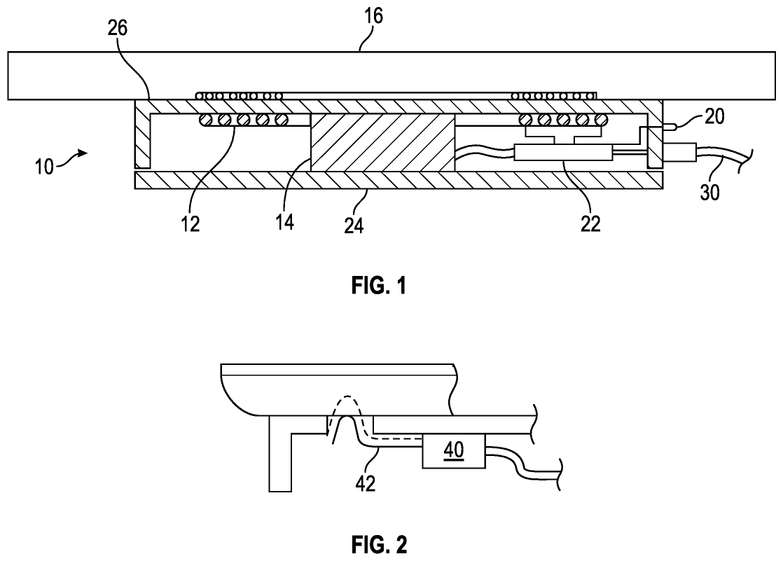

### DETAILED DESCRIPTION OF A PREFERRED EMBODIMENT

The proposed device is a charger 10 with a conventional charging coil 12 for magnetic inductive charging, and may have more than one coil. It has a presence detector 14 that detects the presence of a device 16 to be charged. It has an annunciator 20 to alert a user when a device is present but not aligned for proper charging.

A controller 22 is connected to the charging coil, annunciator, and the presence detector. The controller operates to assess whether or not a device is presently charging by means such as measuring current flowing through the charging coil or other aspects of the charging circuitry. The controller receives a signal from the presence transducer 14 to determine when a device is adjacent to, near, against, or resting on the charger. When the controller detects presence without charging, it delivers a signal or power to the annunciator to alert a user that a device presumably intended for charging is not properly aligned.

The presence detector may be any of a wide range of sensors. It may be anything responsive to the weight of the device, such as a strain gauge or piezoelectric or other transducer used in small scales for weighing light objects. It may be a microswitch protruding through the upper surface of the charger, an optical switch detecting shadowing or reflection from a device on the charger, or any transducer responsive to a shift in position occurring in response to the weight of a device. The presence detector may respond to a momentary effect such as motion in response to the tap or jostle of placing a phone on a charger. It may respond momentarily to contact such as discharging static charge with a capacitive switch. It may be responsive to radio frequencies generated by the device, with a signal strength assessing whether a bluetooth device is so nearby that charging is intended. It may be a photo-detector that detects when a device blocks ambient light in an abrupt transition.

The presence detector in the illustrated embodiment is a scale that weighs the device to assess whether it is an intended device of a certain weight to be charged, as opposed to clutter such as a book or coffee cup that is resting on the charger, with a clearly different weight. The presence detector may simply have a weight threshold above which an intended device is presumed. This threshold may be adjusted or programmed depending on the intended devices, such as phone, watch, ear phones.

The presence detector and controller may include circuitry that detects a nearby object with metal components, and this may be done with a second coil (not shown) or employing the existing coil, switched to a detection circuit instead of the charging circuitry. Unlimited other alternatives include vibration generators and sensors that detect the dampening effect of a present device.

The annunciator may be a light or a noise maker. It may flash or sound briefly initially, or continually or intermittently until the device is removed or properly aligned to initiate charging. The annunciator may be a signal generator that sends a radio frequency or other signal to a separate device such as the device to be charged, so that it can alert the user in the event misalignment occurs.

The controller is responsive to a condition in which a device is present, but not properly aligned for charging. Thus, it includes circuitry and functionality to determining whether or not charging current is flowing to the charging coil, or not.

Because the controller responds to device presence without charging occurring, it requires a feature to ensure against actuation of the annunciator when a charge is successfully completed (such as during the night on a bedside application) and thus no charging is occurring. The controller may have a timer or other timing control to disable the annunciator or otherwise not activate the annunciator except initially for an interval during which device positioning is occurring. The controller may detect the eventual cessation of charging without change in the presence detection to determine a successful completed charge, and disable the annunciator until after an interval, or other detected actions. This may avoid a problem with a phone that is bumped or accessed briefly when fully charged, and then replaced. For such instances, a defeat or mute switch connected to the controller can be operated by the user to avoid continued annunciation. The presence detector such as a weight sensor or switch may be used for the mute function by a signal such as a “double tap” or even a sequence of removal replacement of the device.

The charger may have a base 24 that contacts a table top, and a top 26 that supports the device, with the presence sensor connecting the base and top in some embodiments as shown. The coil is preferably on the top, but may be on either part. A power cord 30 connects the controller to an external power source.

I claim:

1. A charger for an electronic device having a wireless transducer, the charger comprising;
a frame having a device support surface configured to support the device;
a charging element connected to the frame and configured to transmit charging energy to the transducer of a device on the support surface;
a sensor connected to the frame and operable to determine whether a device is present on the support surface;
an annunciator;
a controller connected to the frame, to the transducer, to the charging element, and to the annunciator; and
the controller being responsive to determine a fault condition in which the sensor determines that a device is present on the support surface but the charging element is not transmitting charging energy, and to activate the annunciator in response to the fault condition.

2. The charger of claim 1 wherein the sensor is a weight-responsive device.

3. The charger of claim 1 wherein the sensor is a scale.

4. The charger of claim 1 wherein the sensor is a switch.

5. The charger of claim 1 wherein the sensor is at least a portion of the charging element.

6. The charger of claim 1 wherein the annunciator is an audible signaler.

7. The charger of claim 1 wherein the controller is operable to disable actuation of the annunciator upon completion of charging.

8. the charger of claim 1 wherein the controller is operable to disable actuation of the annunciator after a limited initial period of charging without a fault condition.

9. A method of operating a wireless device charger comprising the steps:
determining whether a device is present on the charger;
determining whether charging is occurring; and
if a device is determined to be present but charging is not occurring, generating an alert signal.

10. The method of claim 9 wherein determining whether a device is present is detecting a force on the device.
